(19) United States
(12) Patent Application Publication
(10) Pub. No.: US 2006/0029743 A1
(43) Pub. Date: Feb. 9, 2006

(54) Wood preservatives and methods of wood preservation

(76) Inventor: Zhixiong Xue, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/100,295

(22) Filed: Apr. 6, 2005

Related U.S. Application Data
(60) Provisional application No. 60/560,533, filed on Apr. 8, 2004.

(51) Int. Cl. B05D 3/00; C09D 5/14; C23C 18/00

(52) U.S. Cl. 427/430.1; 427/294; 427/421.1; 106/15.05

(57) ABSTRACT

This invention provides a method for preserving wood using a substantially metal-free wood preservative comprising a sodium-channel blocking insecticide and at least one fungicide selected from the group consisting of conazoles and ergosterol biosynthesis inhibitors. This invention also relates to such wood preservative formulations.

### FIELD OF THE INVENTION

This invention provides a method for preserving wood using a substantially metal-free wood preservative comprising a sodium-channel blocking insecticide and at least one fungicide selected from a group consisting of conazoles and ergosterol biosynthesis inhibitors. This invention also relates to such wood preservative formulations.

### BACKGROUND

Chromated copper arsenate (CCA) is a commonly used wood preservative that protects wood against attack by wood-rotting fungi and wood-destroying insects. Although CCA is effective and provides long-lasting protection, concerns about the potential health and environmental impact of leachate from CCA-treated wood are curtailing its use.

There is a need for an alternative wood preservative that does not present the potential health and environmental concerns of CCA or other heavy metal-containing compounds and that is effective at low application rates.

### SUMMARY OF THE INVENTION

This invention provides a wood-preserving composition comprising:
a) a sodium-channel blocking insecticide with structure (I), 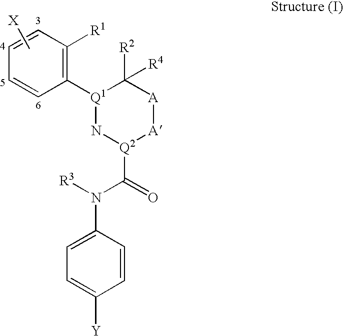
wherein
R¹=H,
R² is H or C₁-C₄ alkyl; or
R¹ and R² can be taken together to form —O—, —CH₂—, —CH₂CH₂—, or —OCH₂—;
Q¹-N-Q² is C═N—N or N—N═C;
A and A′ are independently O, CH₂, NH, or NR′, provided A and A′ are not both 0 or both NR′; or
A and A′ are taken together as CH₂;
R′=H or alkyl;
R³=H, allyl, propargyl, alkyl, CO₂R″, COR″, or CH₂CO₂R″;
R⁴=aryl, CO₂R″, or alkyl;
R″=alkyl;
X=H, halogen, OCH₂R_{f}, R_{f}, or OR_{f} (where R_{f}=fluoroalkyl); and
Y=alkyl, halogen, OR_{f}, R_{f}, alkoxy, or nitro; and
b) a fungicide selected from a group consisting of conazoles and ergosterol biosynthesis inhibitors.

This invention also provides a method for preserving wood, comprising contacting wood with a wood-preserving composition comprising:
a) a sodium-channel blocking insecticide with structure (I), 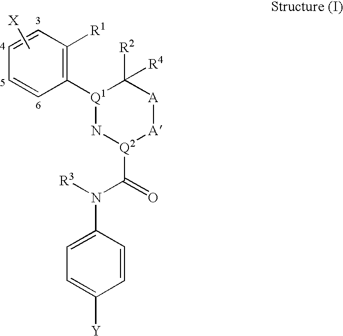
wherein
R¹=H,
R² is H or C₁-C₄ alkyl; or
R¹ and R² can be taken together to form —O—, —CH₂—, —CH₂CH₂—, or —OCH₂—;
Q¹-N-Q² is C═N—N or N—N═C;
A and A′ are independently O, CH₂, NH, or NR′, provided A and A′ are not both O or both NR′; or
A and A′ are taken together as CH₂;
R′=H or alkyl;
R³=H, allyl, propargyl, alkyl, CO₂R″, COR″, or CH₂CO₂R″;
R⁴=aryl, CO₂R″, or alkyl;
R″=alkyl;
X=H, halogen, OCH₂R_{f}, R_{f}, or OR_{f} (where R_{f}=fluoroalkyl); and
Y=alkyl, halogen, OR_{f}, R_{f}, alkoxy, or nitro; and
b) a fungicide selected from a group consisting of conazoles and ergosterol biosynthesis inhibitors.

This invention also provides articles treated with the wood-preserving methods of this invention.

### DETAILED DESCRIPTION OF THE INVENTION

This invention provides a method for preserving wood and protecting it against attack by wood-rotting fungi and wood-destroying insects. The method of this invention is suitable both for combating an acute attack by insects and/or fungi and for preventive protection against insects and/or fungi. The method of this invention is suitable for use with many types and forms of wood, including timbers, freshly milled or aged lumber, and a wide variety of hard and soft woods. It can also be used to protect wood products such as laminated products, plywood and oriented strand board either by treating the wood before it is incorporated into the wood product, or by treating the wood product itself.

The invention is practiced by contacting the wood with a composition comprising a suitable fungicide and a sodium-channel blocking insecticide of structure (I) 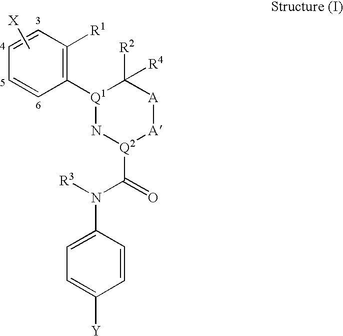
wherein
R¹=H,
R² is H or C₁-C₄ alkyl; or
R¹ and R² can be taken together to form —O—, —CH₂—, —CH₂CH₂—, or —OCH₂—;
Q¹-N-Q² is C═N—N or N—N═C;
A and A′ are independently O, CH₂, NH, or NR′, provided A and A′ are not both O or both NR′; or
A and A′ are taken together as CH₂;
R′=H or alkyl;
R³=H, allyl, propargyl, alkyl, CO₂R″, COR″, or CH₂CO₂R″;
R⁴=aryl, CO₂R″, or alkyl;
R″=alkyl;
X=H, halogen, OCH₂R_{f}, R_{f}, or OR_{f} (where R_{f}=fluoroalkyl); and
Y=alkyl, halogen, OR_{f}, R_{f}, alkoxy, or nitro.

Suitable insecticides for use in the wood-preservative composition of this invention are selected from a group consisting of pyrazolines, indazoles, oxyindazoles, pyrazoline carboxanilides, pyridazines, oxadiazines, tricyclic pyridazines, tricyclic oxadiazines, and tricyclic triazines, all as described by Structure (I).

In one embodiment, X is halogen (F, Cl, or Br) or CF₃, most preferably in the 4-position.

In another embodiment, R¹ and R² taken together are CH₂.

In another embodiment, Q¹-N-Q² is C═N—N.

In another embodiment, A is O or CH₂ and A′ is CH₂, or A′ is O and A is CH₂.

In another embodiment, R³ and R⁴ are CO₂Me, wherein Me is methyl.

In another embodiment, Y is CF₃ or OCF₃.

In a further embodiment, indoxacarb and its metabolite are the insecticide. Indoxacarb is a common name assigned by the International Organization for Standardization (ISO) to methyl (4aS)-7-chloro-2,5-dihydro-2-[[(methoxycarbonyl)[4-(trifluoromethoxy)phenyl]amino]carbonyl] indeno[1,2-e][1,3,4]oxadiazine-4a(3H)-carboxylate. Of note is a mixture of indoxacarb and its inactive (R)-isomer in a ratio from 30:70 to 100:0. Also of note is a 1:1 mixture of indoxacarb and its inactive (R)-isomer. Also of note is a 3:1 mixture of indoxacarb and its inactive (R)-isomer. Of particular note is indoxacarb with less than 5% of its inactive (R)-isomer.

In the above recitations, the term “alkyl,” used either alone or in compound word “fluoroalkyl” includes straight-chain or branched alkyl, such as, methyl, ethyl, n-propyl, i-propyl, or the different butyl isomers. “Alkoxy” includes, for example, methoxy, ethoxy, n-propyloxy, isopropyloxy, and the four different butoxy isomers. The term “halogen” includes fluorine, chlorine, bromine, and iodine. Further, when used in compound words “fluoroalkyl”, “alkyl” may be partially or fully substituted with fluorine atoms. Examples of “fluoroalkyl” include F₃C, HF₂C, and CF₃CH₂. Generally C₁-C₆ alkyl and fluoroalkyl groups are preferred.

By “aryl” is meant a monovalent aromatic group in which the free valence is to the carbon atom of an aromatic ring. An aryl may have one or more aromatic rings that may be fused, connected by single bonds or other groups.

The wood-preservative composition of this invention contains at least one sodium-channel blocking insecticide. In addition to the sodium-channel blocking insecticide(s), the wood-preservative composition can also contain one or more insecticides that function by a mode of action other than sodium channel blocking. For example, carbamate and organophosphate insecticides function as acetylcholine esterase inhibitors and can be used in combination with sodium-channel blocking insecticides. Suitable organophosphate insecticides include chlorpyrifos and dichlorvos. Other insecticides that can be used in combination with sodium-channel blocking insecticides include fenvalerate and fipronil.

The wood preservative compositions of this invention contain fungicides selected from the groups of fungicides active against wood-rotting basidiomycetes. The fungicide(s) comprise one or more fungicides selected from the group of conazoles and ergosterol biosynthesis inhibitors to prevent the growth of white rot, brown rot, and soft rot fungi, which are the major causes of wood decay in untreated wood. Conazoles useful in this invention include climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P. Ergosterol biosynthesis inhibitors useful in this invention include morpholine fungicides such as aldimorph, benzamorf, carbamorph, dimethomorph, dodemorph, fenpropimorph, flumorph, and tridemorph.

Other fungicides that have been found to be effective against one or more wood-rotting fungi include carboxin, iprodione, fenpiclonil, triphenyl boron, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, and benomyl. These fungicides can be used in combination with one or more conazoles or ergosterol biosynthesis inhibitors in the invention.

Combinations of fungicides that are especially effective are those in which the separate fungicides have different and complementary modes of action. Fungicides as a group are known to exhibit a wide variety of modes of action. These modes of action function as uncouplers, kinase inhibitors, or metal chelators, or are known to affect such metabolic activities as succinate dehydrogenation, respiration, tubulin formation, nucleic acid biosynthesis, cell division, acetaldehyde dehydrogenation, or methionine biosynthesis. For example, the triazole fungicides (e.g., flusilazole, tebuconazole, and propiconazole) function as sterol biosynthesis inhibitors. Applicants have found that a conazole (such as flusilazole) in combination with carbendazim (a carbamate that affects tubulin formation) or fenpropimorph (a morpholine that also functions as an ergosterol biosynthesis inhibitor) provide synergistic protection against wood-rotting fungi.

In the wood-preserving method of this invention, the wood to be preserved is contacted with a suitable fungicide (as described above) and a sodium-channel blocking insecticide (as described above). The wood can be contacted sequentially with the insecticide and fungicide, or the insecticide and fungicide can be combined with a carrier solvent and other additives in a wood preservative formulation.

Suitable carrier solvents include both polar and non-polar organic solvents, water, and mixtures of the foregoing, depending on the process used to apply the wood preservative formulation and the active agent or combination of agents used. Aqueous or organic-aqueous solutions, emulsions, and/or suspensions may be used. To increase or improve the solubility of the active agents in the liquid carrier, emulsifiers or solubilizers may be employed.

Polar organic solvents useful in the invention are those that contain hydroxy, ether, keto, or ester groups. Embodiments of the invention include polar solvents that are alcohols, glycols, glycoether diacetone alcohol, water-insoluble polyols, and their esters.

Suitable non-polar solvents include aliphatic and aromatic hydrocarbons, including mineral oils, naphtha, spindle oil, petroleum, turpentine oil, terpene hydrocarbons, and alkyl benzenes.

Suitable additives include fixing agents, softeners, emulsifiers, cross-linking agents, solution mediators, pigments, dyes, anti-corrosion agents, odor correctors, pH-regulators, UV-stabilizers, waxes and drying oils.

The sodium-channel blocking insecticide is present in the wood preservative formulation at a concentration of from about 1 ppm to 10 wt % of the total weight of the formulation. The fungicide is present in the wood preservative formulation at a concentration of from about 1 ppm to 10 wt %. In an embodiment of the invention, the ergosterol biosynthesis inhibitor constitutes at least 50 mole % of the fungicide in the wood preservative formulation.

In the wood preserving method of this invention, contacting the wood can be carried out by coating, painting, spraying, atomizing, dipping, or impregnating the wood with an effective amount of the wood preservation formulation. Suitable impregnation processes include soaking, dipping, pressure, vacuum and double-vacuum processes. Pressure processes are especially useful for large pieces of wood, or for wood that will be used in contact with water or moist soil or in areas infested with termites or other wood-destroying insects.

### EXAMPLES

### Example 1

### Protocol For 6-Well Plate Assay To Identify Active Wood-Preserving Agents

The minimal inhibitory concentration of fungicides against eight fungi was determined in 6-well microtiter plates. Minimal inhibitory concentration is defined as the lowest concentration at which no fungus growth is evident after seven days. The results are shown in Table 1. A group of eight fungi were used in a screen to identify potential active ingredients to preserve wood. The eight fungi, their classification, and the growth media used to culture them are listed below:

| | Classification | |
|---|---|---|
| Fungi | Type | Growth Medium |
| Gloeophyllum trabeum | brown rot | potato dextrose yeast agar (PYD |
| | | agar) |
| Postia placenta | brown rot | YM agar |
| Aspergillus niger | common mold | PD agar (potato dextrose agar) |
| Chaetomium globosum | soft rot | mineral salts agar |
| Trametes versicolor | white rot | ME (malt extract) agar |
| Irpex lacteus | white rot | ME agar |
| Phanerochaete | white rot | ME agar |
| chrysosporium | | |
| Antrodia vaillantii | brown rot | ME agar |

Growth media were purchased from Difco (from Beckton Dickinson and Co., Sparks, Md.). The growth media were added to water to 2% w/v and autoclaved at 121° C. for 30 min. Autoclaved media were allowed to cool down to ˜50° C. Test chemicals were dissolved in DMSO (dimethyl sulfoxide) individually at 10 mg/mL to generate stock solutions. An appropriate amount of a stock solution was then added to the appropriate growth medium at 50° C. to make up the test media containing various concentrations of individual test chemicals. 10 mL of the medium was added to each well of a 6-well plate and allowed to solidify at room temperature. For each plate, the first well had no chemical, and the remaining five wells contained a particular test chemical at five different concentrations. Eight such plates were prepared for each chemical, using the eight media listed above for the eight test organisms.

After the media solidified and cooled, a plug (˜2 mm×2 mm) of agar growth medium with fresh grown mycelium from the appropriate fungal culture was used to inoculate each well. The plate was placed in an incubator, and the growth of the fungus monitored. After 4 to 7 days, the growth was scored manually.

TABLE 1
Effectiveness at Inhibiting Wood-Rotting Fungi

| Fungicide | BR1 | BR2 | BR3 | SR1 | WR1 | WR2 | WR3 |
|---|---|---|---|---|---|---|---|
| Propiconazole | 1 | 1 | 1 | 1 | 1 | 1 | 1 |
| Tebuconazole | 1 | 1 | 1 | 2 | 1 | 1 | 1 |
| Fluazinam | 1 | 1 | 1 | 1 | 2 | 2 | 2 |
| Flusilazole | 1 | 2 | 1 | 1 | 1 | 2 | 2 |
| Carboxin | 2 | 1 | 1 | 2 | 1 | 1 | 1 |
| Fenpropimorph | 1 | 1 | 2 | 3 | 2 | 2 | 2 |
| Baytan | 2 | 1 | 1 | 3 | 1 | 1 | 1 |
| Ferbam | 1 | 3 | 2 | 2 | 2 | 2 | 2 |
| Prochloraz | 3 | 3 | 2 | 1 | 2 | 2 | 2 |
| Carbendazim | 2 | 3 | 2 | 1 | 3 | 2 | 2 |
| Benomyl | 2 | 3 | 2 | 1 | 3 | 3 | 2 |
| 8-Hydroxyquinoline | 2 | 3 | 1 | 3 | 2 | 2 | 3 |
| Terrazole | 3 | 3 | 2 | 3 | 1 | 1 | 1 |
| Axoxystrobin | 1 | 1 | 1 | 3 | 3 | 3 | 3 |
| Trifloxystrobin | 2 | 1 | 1 | 3 | 3 | 3 | 3 |
| Pentachloronitro- | 2 | 2 | 3 | 1 | 3 | 3 | 3 |
| benzene | | | | | | | |
| 5-Fluorocytosine | 1 | 3 | 2 | 3 | 2 | 3 | 3 |
| Thiabendazole | 3 | 3 | 3 | 1 | 3 | 3 | 3 |

BR1 = Postia placenta
BR2 = Gloeophylium
BR3 = Antrodia vaillantii
SR1 = Chaetomium globosum
WR1 = Trametes versicolor
WR2 = Irpex lacteus
WR3 = Phanerochaete chrysosporium
“1” indicates effective inhibition at 1 ppm or less
“2” indicates inhibition at about 1-100 ppm
“3” indicates inhibition (if any) only at >100 ppm

### Example 2

### Soil Block Test of Flusilazole Formulations

For the soil block tests, the protocol listed as AWPA (American Wood Preservers' Association) standard E10-01 was used, with some modifications that are noted.

For pressure treatment, wood blocks (¾ inch cubes) were made from Southern yellow pine (SYP) or birch dried at about 40° C. to constant weight, and weighed before pressure treatment. In a typical experiment, blocks were submerged in an appropriate treatment solution in an autoclave. A vacuum of 10 to 15 inch Hg (380 to 510 torr) was applied for 30 min, followed by a pressure of 150 psi (1.034 MPa) for 1 hr. The treatment solution was then removed and a vacuum of 10 to 15 inch Hg (380 to 510 torr) was applied again to the blocks for 15 min. Excess treatment solution on the surface was allowed to evaporate (30 min in a laboratory fume hood) before the blocks were either weighed or stored in a sealed plastic bag and weighed at a later time.

For the soil block test, wood blocks were conditioned in a vented incubator at 40° C. until they reached a constant weight (16 to 18 hrs). Blocks were then autoclaved at 100° C. for 30 min under dry cycle. Soil samples with a water holding capacity of 40% were used for these tests. 60 mL of water and 92-100 g of soil were added into a 228 mL French square bottle, and autoclaved at 121° C. for 30 min. A feeder strip, ⅛″×1⅛″×1⅜″ (˜0.31 cm×2.86 cm×3.49 cm), birch for birch blocks and SYP for SYP blocks, was placed on the top of the soil. A testing block was placed on top of the feeder strip and the bottle contents inoculated with an agar strip (˜3 mm×30 mm) containing freshly grown fungus (listed in the results). For brown rot fungi (Postia placenta), SYP blocks and feeder strips were used. For white rot (Irpex lacteus), birch blocks and feeder strips were used. The bottles were loosely capped and allowed to incubate at ˜75% humidity and 25° C. for 3 months. Then the blocks were removed from the bottles and dried at 40° C. to constant weight in a vented incubator (16-18 hr). The weight of each block was determined and the percent weight loss was calculated.

Solutions of 5% acetic acid and flusilazole at 50, 100, 200 ppm were made by mixing an appropriate volume of a 100 mg/mL stock solution of flusilazole in DMSO, water, and glacial acetic acid. Wood blocks were treated with these solutions as described above. As a control, a 2% DMSO/5% acetic acid solution was also made and used to treat a set of blocks.

Blocks were allowed to age for a week in the fume hood after treatment. Half of the blocks were subjected to leaching with water for an additional week before undergoing the soil block test. For leaching, blocks were placed in a beaker and 30 mL of water per block were added. Blocks were allowed to incubate at room temperature under constant stirring, with daily change of water for one week.

TABLE 2
Average weight loss, %

| P. placenta | SYP blocks | I. lacteus | birch blocks |
|---|---|---|---|
| Untreated block | 47.6 | Untreated block | 43.7 |
| Control | 37 | Control | 24.22 |
| 50 ppm Flusilazole | 29 | 50 ppm Flusilazole | 19.5 |
| 100 ppm Flusilazole | 19 | 100 ppm Flusilazole | 21.7 |
| 200 ppm Flusilazole | 3.3 | 200 ppm Flusilazole | 11 |

These results indicate that SYP blocks treated with the 200 ppm flusilazole solution were protected against decay caused by the brown rot fungus P. placenta. Birch blocks treated with the same solution were also significantly protected from decay by white rot fungus I. lacteus.

### Example 3

### Soil Block Tests of Flusilazole/Fenpropimorph Formulations

In an emulsion-based formulation containing 160 g/L flusilazole and 375 g/L fenpropimorph, Pluton® triazole-based agricultural fungicide (DuPont Ag Products, Wilmington, Del.), was tested for its ability to protect wood against brown and white rot fungi.

Pluton® fungicide was diluted in water to 0.2, 0.5 and 1%, and the solutions used to treat SYP and birch blocks as described above. The active ingredient concentrations in these solutions are 320 ppm flusilazole, 750 ppm fenpropimorph for the 0.2% solution; 800 ppm flusilazole, 1775 ppm fenpropimorph for the 0.5% solution, and 1600 ppm flusilazole, 3750 ppm fenpropimorph for the 1% solution. Leaching and soil block testing were done as described in Example 2 above.

TABLE 3
Average weight loss, %

| | |
|---|---|
| Brown rot, SYP blocks | White rot, birch blocks |

| | | | |
|---|---|---|---|
| Untreated block | 43.3 | Untreated block | 45.4 |
| 0.2% | −1.67 | 0.2% | 0.85 |
| 0.5% | −2.4 | 0.5% | −2.0 |
| 1% | −2.4 | 1% | −2.1 |

As indicated by these results, even a solution of 320 ppm flusilazole +750 ppm fenpropimorph offers excellent protection against both P. placenta and I. lacteus when used to treat SYP and birch blocks.

### Example 4

### Soil Block Tests of Flusilazole/Carbendazim Formulations

Flusilazole (0.75 g) and carbendazim (0.75 g) were dissolved in 150 mL DMSO. This solution was added under stirring to 1.8 L of 7% acetic acid, and the final volume was adjusted to 2 L with water. The resulting solution contained 7.5% DMSO; 6% acetic acid, and 375 ppm each of flusilazole and carbendazim. The solution was slightly cloudy but no precipitate settled when the solution was left standing at room temperature for a week.

SYP blocks were pressure-treated with this solution as above (Example 2). After treatment, the blocks were divided into groups and allowed to age in the hood for either two days or 14 days. The blocks were then placed in a beaker and submerged under water (50 mL water per block), under constant stirring for two weeks. Water was changed daily except on weekends. After two weeks, the blocks were dried in 40° C. incubator to constant weight, as described in Example 2, and used for soil block test.

Two brown rot fungi, G. trabeum and P. placenta, were used in this soil block test. The procedure is the same as in Example 2, except 1) only SYP blocks and feeder strips were used, and 2) the fungi G. trabeum replaced I. lacteus.

TABLE 4
Average weight loss, %

| | |
|---|---|
| G. trabeum. | P. placenta |

| | | | |
|---|---|---|---|
| Untreated block | 38.5 | Untreated block | 48.9 |
| 2 day fixing | 5 | 2 day fixing | 0 |
| 2 week fixing | 3.9 | 2 week fixing | 0.4 |

As indicated by these results, 375 ppm each of flusilazole and carbendazim offered good protection against P. placenta and G. trabeum. Fixing time did not make a major difference in the outcome.

### Example 5

### Soil Block Tests of Flusilazole and Carbendazim

A formulation containing 23.2% flusilazole and 11.2% (w/w) carbendazim was also tested for its ability to protect wood. A 1% (w/v) solution was used to treat SYP blocks as described in Example 2. This solution contained 2,500 ppm (0.25 wt %) flusilazole and 1,250 ppm carbendazim. SYP blocks were treated, aged, leached, and tested using the same procedures as in Example 4.

TABLE 5
Average weight loss, %

| | |
|---|---|
| G. trabeum. | P. placenta |

| | | | |
|---|---|---|---|
| Untreated block | 38.5 | Untreated block | 48.9 |
| 2 day fixing | −0.46 | 2 day fixing | −0.44 |
| 2 week fixing | 0.27 | 2 week fixing | −0.38 |

As indicated by these results, treatment of SYP blocks with flusilazole/carbendazim solution offered good protection against both G. trabeum and P. placenta.

### Example 6

### Soil Block Tests of Flusilazole/Carboxin Formulations

Soil block tests using solutions of 5% acetic acid and flusilazole/carboxin at 25 ppm/25 ppm, 50 ppm/50 ppm, and 100 ppm/100 ppm were carried out as described above in Example 5.

TABLE 6
Average weight loss, %

| | |
|---|---|
| Brown rot, SYP blocks. | White rot, birch blocks |

| | | | |
|---|---|---|---|
| Untreated block | 50 | Untreated block | 47.3 |
| 25 ppm/25 ppm | 35 | 25 ppm/25 ppm | 25.6 |
| 50 ppm/50 ppm | 29 | 50 ppm/50 ppm | 27.9 |
| 100 ppm/100 ppm | 30 | 100 ppm/100 ppm | 23.1 |

Calculated loading was ˜40, ˜80, and ˜160 ppm total for SYP and ˜45, ˜100, and ˜200 ppm total for birch.

A flusilazole/carboxin mixture provided less protection than did flusilazole alone.

We claim:

1. A wood-preserving composition, comprising:
a) a sodium-channel blocking insecticide of structure (I), 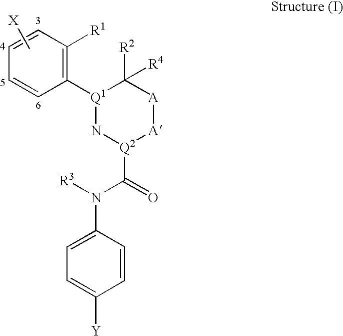
wherein
R1=H,
R2 is H or C₁-C₄ alkyl; or
R1 and R2 can be taken together to form —O—, —CH2—, —CH2CH2—, or —OCH2—;
Q1-N-Q2 is C═N—N or N—N═C;
A and A′ are independently O, CH2, NH, or NR′, provided A and A′ are not both O or both NR′; or
A and A′ are taken together as CH2;
R′=H or alkyl;
R3=H, allyl, propargyl, alkyl, CO2R″, COR″, or CH2CO2R″;
R4=aryl, CO2R″, or alkyl;
R″=alkyl;
X=H, halogen, OCH2Rf, Rf, or ORf; and
Y=alkyl, halogen, ORf, Rf, alkoxy, or nitro; and
b) a fungicide selected from a group consisting of conazoles, ergosterol biosynthesis inhibitors and mixtures thereof.

2. The wood-preserving composition of claim 1, wherein X is selected from a group consisting of F, Cl, Br, and CF3.

3. The wood-preserving composition of claim 1, wherein R1 and R2 taken together are CH2.

4. The wood-preserving composition of claim 1, wherein Q1-N-Q2 is C═N—N.

5. The wood-preserving composition of claim 1, wherein A is O or CH2 and A′ is CH2, or A′ is 0 and A is CH2.

6. The wood-preserving composition of claim 1, wherein R3 and R4 are CO₂Me.

7. The wood-preserving composition of claim 1, wherein Y is CF3 or OCF3.

8. The wood-preserving composition of claim 1, wherein X is 4-Cl, R3 and R4 are CO₂Me, R1 and R2 taken together are CH2, A is 0 and A′ is CH2, Y is OCF3, and Q1-N-Q2 is C═N—N.

9. The wood-preserving composition of claim 1, further comprising insecticides selected from carbamate acetylcholine esterase inhibitors, organophosphate acetylcholine inhibitors and mixtures thereof.

10. The wood-preserving compositions of claim 9, wherein the organophosphate acetylcholine inhibitor is chlorpyrifos or dichlorvos.

11. The wood-preserving composition of claim 1, further comprising fenvalerate or fipronil.

12. The wood-preserving composition of claim 1, wherein the fungicide comprises at least one conazole selected from a group consisting of climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, and mixtures thereof.

13. The wood-preserving composition of claim 12, further comprising an ergosterol biosynthesis inhibitor selected from a group consisting of aldimorph, benzamorf, carbamorph, dimethomorph, dodemorph, fenpropimorph, flumorph, tridemorph, and mixtures thereof.

14. The wood-preserving composition of claim 12, further comprising a fungicide selected from a group consisting of carboxin, iprodione, fenpiclonil, triphenyl boron, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, benomyl, and mixtures thereof.

15. The wood-preserving composition of claim 1, wherein the fungicide comprises at least one ergosterol biosynthesis inhibitor selected from a group consisting of aldimorph, benzamorf, carbamorph, dimethomorph, dodemorph, fenpropimorph, flumorph, tridemorph, and mixtures thereof.

16. The wood-preserving composition of claim 15, further comprising a fungicide selected from a group consisting of carboxin, iprodione, fenpiclonil, triphenyl boron, ferbam, fenpiclonil, capafol, 8-hydroxyquinoline, nabam, oxycarboxin, cyprodinil, chlorothanil, axaoxystrobin, trifloxystrobin, thiram, fluazinam, terrazole, carbendazim, benomyl, and mixtures thereof.

17. The wood-preserving composition of claim 1, further comprising an additive selected from a group consisting of fixing agents, softeners, emulsifiers, cross-linking agents, solution mediators, pigments, dyes, anti-corrosion agents, odor correctors, pH-regulators, UV-stabilizers, waxes, drying oils and mixtures thereof.

18. A process for protecting a wood article from wood-destroying insects or wood-rotting fungi, comprising contacting the wood article with the wood-preserving composition of claim 1 to produce a treated wood article.

19. The process of claim 18, wherein the wood-preserving composition further comprises a solvent selected from a group consisting of polar and non-polar organic solvents, water, and mixtures thereof.

20. The process of claim 18, wherein the contacting comprises coating, painting, spraying, atomizing, dipping, soaking, pressure-, vacuum- or double vacuum-treating the wood article with an effective amount of the wood-preserving composition.

21. A treated wood article produced by the process of claim 18.
